(19) United States
(12) Patent Application Publication
(10) Pub. No.: US 2024/0227483 A9
(43) Pub. Date: Jul. 11, 2024

(54) SUSPENSION ADJUSTMENT ASSEMBLY

(71) Applicant: R5 MSS LTD, Hampshire (GB)

(72) Inventor: William BLANKSON, Hampshire (GB)

(21) Appl. No.: 18/264,106

(22) PCT Filed: Jan. 17, 2022
(86) PCT No.: PCT/EP2022/050854

§ 371 Date: Aug. 3, 2023

(30) Foreign Application Priority Data
Feb. 11, 2021 (GB) 2101902.1

(51) Int. Cl. B60G 17/005; B60G 15/06; B60G 21/055

(52) U.S. Cl. CPC B60G 17/005; B60G 15/063; B60G 21/0551; B60G 17/02; B60G 2202/31; B60G 2204/122; B60G 2204/1242; B60G 2204/61

(57) ABSTRACT

A suspension strut assembly comprises a suspension strut 10 formed by a strut housing 10a having first and second ends and an outer surface, and a strut rod 10b which is telescopically engaged in the first end of the strut housing 10a. A thread 11a is formed on a sleeve 11 which is slideably engaged on the outside of the strut housing 10a. An anti-roll bar collar 13 is screwingly engaged on the outer surface of the strut housing 10a. The collar 13 has a plate 13a extending outwardly thereof for engaging with an anti-roll bar. An annular spring seat 14 is also screwingly engaged on the outer surface of the strut housing 10b between the collar 13 and the first end of the strut housing 10a. The collar 13 and spring seat 14 are each windable along the housing 10a to vary their longitudinal positions on the housing 10a.

### BACKGROUND OF THE INVENTION

### 1. Field of the Invention

The present invention relates to improvements in sprung shock absorbers and more particularly to improvements to anti-roll bar attachment to such shock absorbers.

### 2. The Prior Art

Shock absorbers such as are used on car suspension systems are well known in the art. Typical such shock absorbers comprise a spiral spring which optionally winds around a central fluid filled shock damper strut. More particularly, the strut is formed by a strut housing in which is longitudinally moveable a strut shaft so as to be extendable from and retractable into the strut housing. The strut housing is fluid filled and the end of the strut shaft acts like a piston in said housing so that its longitudinal movement is dampened. A pair of spaced apart spring seats are provided on the strut, one connected to the housing and one to the shaft, such that as the shaft moves into and out of the housing, the spring is compressed or relaxed so as to control the shock absorbing capability of the shock absorber. This compressibility is, therefore, dependent on the spring constant of the spiral spring. IN a configuration without a strut, the spring seats are fixed, respectively to the body of the vehicle and to part of the wheel mount such as a wishbone and the spring extends therebetween.

An additional element of a typical suspension system is the anti-roll bar. This is a bar which extends across the front (front anti-roll bar) and rear (rear anti-roll bar) of the vehicle so as to connect the suspension on either side. The job of the anti-roll bar is to transmit movement of the suspension on one side of the vehicle to the suspension on the other side so as to keep the vehicle level and hence reduce rolling. More particularly, each strut housing has an anti-roll bar mounting bracket formed on its outer surface to which is connected an end of the anti-roll bar so that any movement of the strut housing on one side causes twisting of the roll bar, which is then transmitted to the strut housing on the other side of the car. An example of a typical original manufacturer design is shown in FIG. 1 with the anti-roll bar mounting bracket clearly shown in a faxed position at the bottom of the strut.

Due to the difference in design between different cars, the location of the spring seats and the location of the anti-roll bar mounting brackets usually differs between different cars so that suspension struts cannot usually be interchanged between different vehicles as the anti-roll bar ends will not line up with the mounting brackets and the ride height of the vehicle, which is set by the height of the spring seat, will usually not be correct.

There is an after market for custom suspension parts for vehicles to enable a vehicle owner to change the ride height of the vehicle (by providing a strut with spring seats which are in a different position to the original manufacturer specification), as well as to change the stiffness of the suspension (by changing the spring or springs which are engaged around strut). AN example of such a known after-market product is shown in FIG. 2. This comprises a custom strut with a spring seat which is mounted on the strut housing by means of a threaded interface so as to enable the height of the spring seat on the strut to be adjusted up and down and hence the ride height of the vehicle to be changed. The assembly also includes a custom spring to suit the customer's requirement for stiffness of the suspension. Applicant's own earlier UK Patent Application No. GB 1810595.7 further discloses an arrangement in which an additional adjuster ring is provided between a pair of springs which are arranged in series in a suspension strut to enable a preload between the two springs to be adjusted. However, in all known arrangements, the anti-roll bar mounting bracket is still fixed to the strut housing, and as a result is it still necessary to provide a separate strut design for each vehicle in order to ensure that the bracket is properly positioned to engage with the anti-roll bar end.

The present invention overcomes this issue by providing a suspension strut assembly which provides an adjustable anti-roll bar mounting bracket.

### SUMMARY OF THE INVENTION

More particularly, according to the present invention there is provided a suspension strut assembly comprising a suspension strut formed by a strut housing having a first end, a second end and an outer surface, and a strut rod which is telescopically engaged in the first end of the strut housing, an anti-roll bar collar having a plate extending radially outwardly thereof for engaging, in use, with an anti-roll bar, and an annular spring seat, each of the anti-roll bar collar and the spring seat being threadingly engaged on the outer surface of the strut housing so as to be moveable longitudinally there along, said threaded engagement preventing longitudinal sliding movement of the collar and spring seat along the strut housing, the spring seat being located on the housing between the collar and the first end of the housing.

A suspension strut assembly in accordance with the invention has the advantage that the provision of the anti-roll bar bracket on a moveable collar, longitudinal position of the bracket on the strut can easily be adjusted to suit the location of the anti-roll bar end of different vehicles, thereby enabling the assembly to be fitted to a wide variety of vehicles.

The strut housing preferably has an external male thread associated with its outer surface of the strut housing which extends at least partially between the first and the second end, and each of the collar and the spring seat has an internal thread complementary to the external thread of the housing and being threadingly engaged with the external thread of the housing so as to be windable thereon to move each of the collar and spring seat longitudinally along the strut housing.

The male thread of the strut housing may be formed directly on the outer surface thereof, but preferably is provided on a cylindrical sleeve which is slideably engaged onto the strut housing from the first end thereof. The strut housing preferably then includes a lip or flange which forms a seat for the sleeve to locate the longitudinal position of the sleeve on the strut. Inter-engaging locating means may also be provided on the sleeve and the strut housing which engage to lock the sleeve to the housing against relative rotational movement when the sleeve is engaged on the lip or flange. IN a particularly preferred embodiment, the housing has a longitudinally extending rib formed on its outer surface which engages in a longitudinal slot formed in the sleeve to non-rotatably lock the two together.

Preferably locking means is associated with the collar which operates to lock the collar against movement relative to the housing in at least one direction. The locking means may be one or more locking screws such as a grub screw provided in the collar, but preferably the locking means takes the form of a locking ring which is screwingly engagement with the male thread of the strut housing and is engaged on the strut housing between the collar and the second end of the strut housing. IN this way, the locking ring can be wound up against the bottom of the collar once the spring seat is in the desired position to prevent further movement of the collar towards the second end of the housing. A second locking ring may also be provided in threaded engagement with the housing between the collar and the spring seat, said second locking ring being engageable with the top of the collar in order to prevent movement of the collar towards the first end of the housing.

IN an alternative embodiment, each of the collar and the spring seat may be slideably engaged with the outer surface of the housing instead of threadingly engaged, and the means for preventing longitudinal sliding movement of the collar and spring seat along the strut housing comprises locking means associated with each of the collar and the spring seat which engages with the strut housing to prevent longitudinal movement of each of the collar and the spring seat relative to the housing in at least one direction. In particular the locking means may be locking screws provided in the collar and spring seat which are tightened to engage with the strut housing.

The present invention further provides a kit for forming a suspension strut assembly according to the invention, comprising a suspension strut formed by a strut housing having a first end, a second end and an outer surface, and a strut rod which is telescopically engaged in the first end of the strut housing, an anti-roll bar collar having a plate extending radially outwardly thereof for engaging, in use, with an anti-roll bar, and an annular spring seat, each of the anti-roll bar collar and the spring seat being threadingly engageable on the outer surface of the strut housing so as to be moveable longitudinally there along, said threaded engagement preventing longitudinal sliding movement of the collar and spring seat along the strut housing, the spring seat being locatable on the housing between the collar and the first end of the housing.

The present invention still further provides an anti-roll bar collar for a kit according to the invention, comprising a collar having an inner circumferential surface having a female thread formed thereon sized to engage, in use, with the threaded outer surface of a strut housing so as to be longitudinally moveable there along, said threaded engagement preventing, in use, longitudinal sliding movement of the collar along the strut housing, and a plate extending radially outwardly thereof for engaging, in use, with an anti-roll bar.

### BRIEF DESCRIPTION OF THE DRAWINGS

In order that the invention may be well understood, there will now be described some embodiments thereof, given by way of example, reference being made to the accompanying drawings, in which:

FIG. 1 is a perspective view of a conventional OEM suspension strut assembly according to the prior art;

FIG. 2 is a perspective view of an aftermarket suspension strut assembly according to the prior art;

FIG. 3 is a perspective view of a suspension strut assembly according to the present invention;

FIG. 4 is a perspective view of a threaded sleeve which forms part of the strut assembly of FIG. 3;

FIG. 5 is a sectional view of the sleeve of FIG. 4;

FIG. 6 is a perspective view of an anti-roll bar mounting collar which forms part of the strut assembly of FIG. 4;

FIG. 7 is a perspective view of an adjustable spring seat which forms part of the strut assembly of FIG. 4;

FIG. 8 is a perspective view of a locking ring which forms part of the strut assembly of FIG. 4;

FIG. 9 is a perspective view from a first angle of the strut assembly of FIG. 4 connected to an anti-roll bar in an installed configuration; and

FIG. 10 is a perspective view from a second angle of the strut assembly of FIG. 4 connected to an anti-roll bar in an installed configuration.

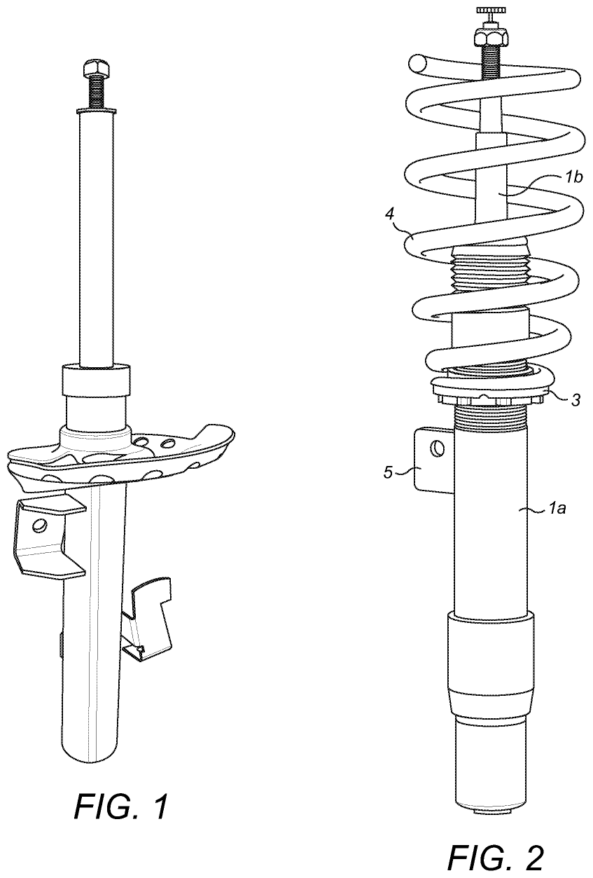

### DETAILED DESCRIPTION OF THE PREFERRED EMBODIMENTS

Referring first to FIG. 2, there is shown an example of an aftermarket suspension strut assembly according to the prior art. A suspension strut 1 is provided which has a lower strut housing 1a and an upper strut rod 1b which telescopically extends from and retracts into the strut housing, said movement being dampened by a viscous fluid which is contained within the housing 1a in a known manner. The outer surface of the housing 1a has a threaded portion 2 formed thereon proximate its upper end on which is screwingly engageable a spring seat ring 3 for supporting a lower end of a suspension spring 4. An anti-roll bar mounting bracket 5 in the form of a radially extending plate it welded to the outer surface of the housing 1a below the threaded portion 2, the location of the plate being set depending on the design of the vehicle on which it is to be used.

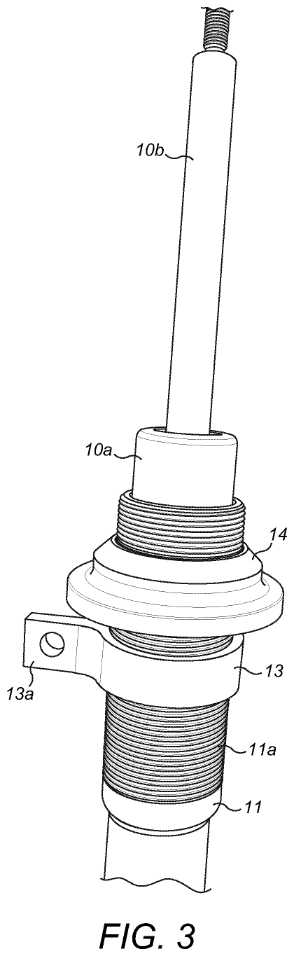

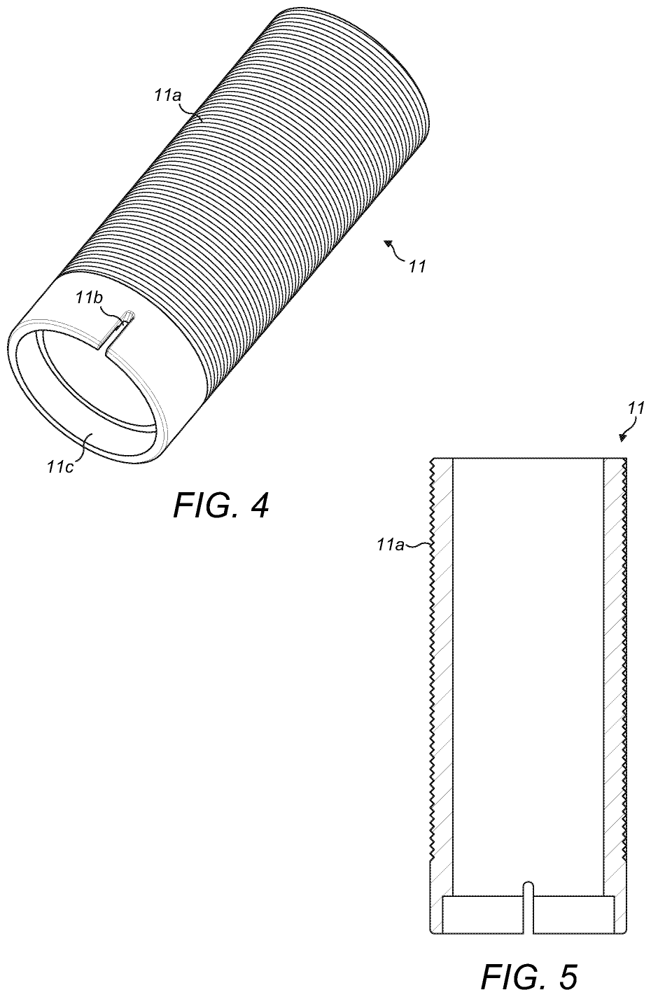

FIG. 3 shows a solution according to the present invention Like the prior art assembly of FIG. 2, the strut 10 of the assembly of FIG. 3 is formed by a lower strut housing 10a and an a upper strut rod 10b which is telescopically extendable out of and retractable into the strut housing 10a in a conventional manner. The strut housing 10a furthermore has a male thread 11a associated with its outer surface and extending from an upper end of the housing 10a along a substantial portion of the housing 10a. More particularly, in the illustrated embodiment, a threaded cylindrical sleeve 11, shown in FIGS. 4 and 5, which has the male thread 11a cut into its outer surface is slidingly engageable over the strut housing 10a. The lower end of the sleeve 11 engages with a flange formed on the strut housing to seat it on the housing 10a at the correct longitudinal position. As shown in FIG. 4, the internal through opening of the sleeve 11 has an enlarged portion 11c extending from its lower end which locates with the flange on the strut housing 10a. The sleeve 11 furthermore has a slot 11b extending longitinally upwards from the bottom end which is sized and shaped to engage a longitudinal rib formed on the outer surface of the strut housing 10a to non-rotatably lock the two parts together when they are engaged. Whilst the illustrated embodiment shows the thread being formed on a separate sleeve, it would also be possible for the thread to be cut directly into the outer surface of the strut housing 10a.

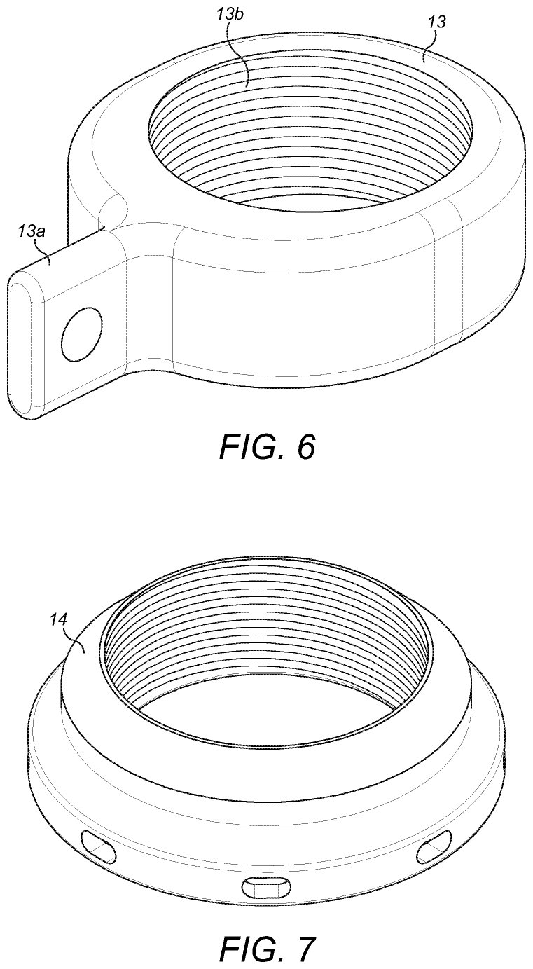

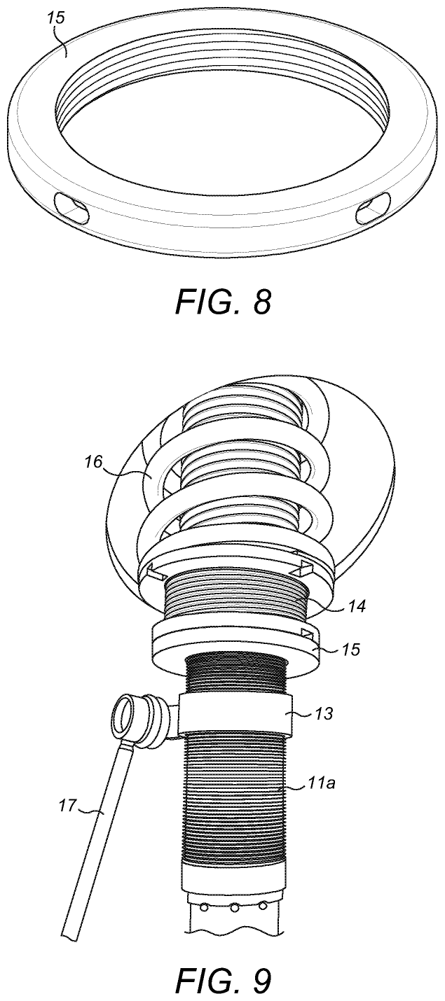

The assembly further comprises a collar 13, shown in FIG. 6, which has a wing 13a extending radially outwardly from its outer surface, the wing 13a forming a mounting bracket for an anti-roll bar end of a vehicle. The collar 13 has a thread 13b formed in its inner surface which is complementary to the male thread associated with the outer surface of the strut housing 10a such that the collar 13 is screwingly engageable with the housing 10a so as to be windable up and down therealong to adjust its position along the housing 10a. IN this way, the height of the wing 13a on the strut can be adjusted to match the height requirement of the anti-roll bar end of any vehicle. The collar may be provided with locking means such as a locking screw or the like, operable to lock the collar 13 to the housing 10a against further rotational movement once the collar is in the correct position for the vehicle. However, once the anti-roll bar end is connected to the wing 13a as shown in FIGS. 8 and 9 it will be prevented from rotating and hence the locking means is not essential.

Screwingly engaged with the thread 11a of the strut housing 10a above the collar 13 is a threaded spring seat 14 shown in FIG. 7 and below the collar 13 is a lock ring 15 shown in FIG. 8. Like the collar, both the spring seat 14 and lock ring 15 have a female thread cut into their inner cylindrical surface which complements the male thread 11a of the strut housing 10a so that each can be wound up and down the sleeve 11 to adjust their vertical position on the strut housing 10a. The locking ring 15 operates to lock the collar against further downward movement which could result from the torsional load which is applied by the anti-roll bar. This is achieved by the locking ring 15 being wound up the strut into abutment with the bottom of the collar 13 when the collar 13 is in its correct position, the locking ring 15 acting as a stop for the collar 13. Optionally, an upper locking ring, positioned between the collar 13 and the spring seat 14, could be provided to provide an upper stop for the collar 13. The spring seat 14 could also be designed with a moveable flange on it against which the bottom of the spring abuts, allowing the spring seat to be located in abutment with the top of the collar to act as an upper stop, the adjustable flange then being moved to the desired position for the bottom of the spring. It will be understood that instead of being threaded onto the strut housing 10a, the locking ring could be a slide fit thereon and include locking means such as locking screws to secure it in place.

The spring seat 14 provides the lower support for the suspension spring which will carry the weight of the vehicle on it, and due to the weight being applied axially on the spring seat, unintentional rotation is not an issue and hence a lock ring for the spring seat is generally not warranted although it could be provided if desired.

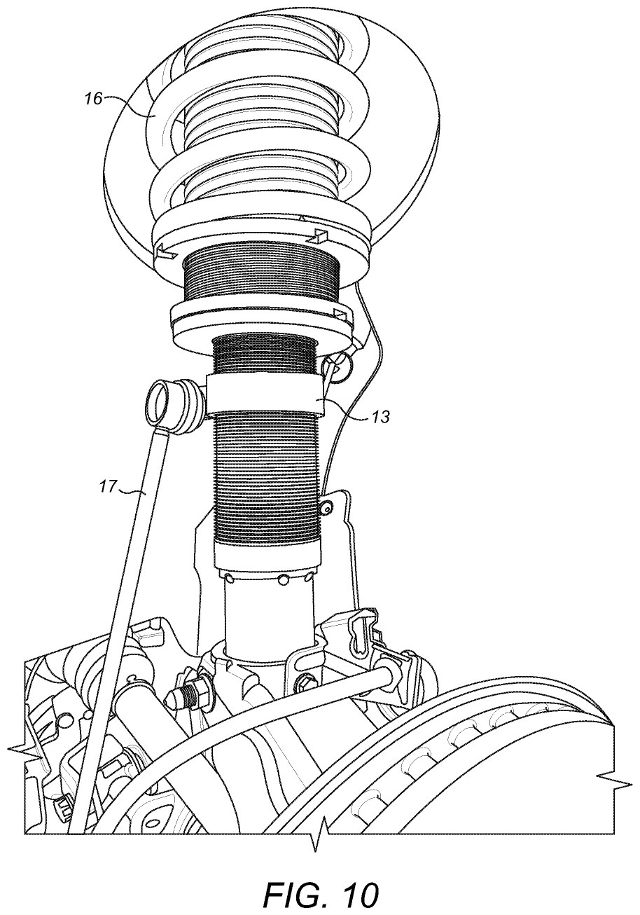

FIGS. 9 and 10 show the strut assembly of the invention installed in a vehicle with a suspension spring 16 engaged on the spring seat 14 (in this case an adjustable spring seat which has an adjuster plate screwingly engaged on a threaded outer surface of the spring seat) and an anti-roll bar end 17 attached to the mounting bracket formed by the wing 13a using a conventional mount.

The assembly is installed by first fitting the sleeve 11 onto the strut housing 10a and then screwing the locking ring 15 onto the sleeve 11 followed by the collar 13 and finally the spring seat 14 supper most. The suspension spring 16 is then engaged over the strut rod 10b and engaged with the spring seat 14 before the upper and lower ends of the strut are engaged with between the vehicle body and lower suspension arm of the vehicle in a conventional manner. The collar 13 is then wound up or down the sleeve 11 as required to position the wing 13a correctly for engagement with the anti-roll bar end 17. This may be achieved by rotating the collar itself or by rotating the strut and sleeve 11 together whilst keeping the collar 13 still. Once the collar is correctly positioned, the locking ring 15 is then wound up into abutment with the underside of the collar 13. The spring seat is then be wound up or down to attain the required ride height for the vehicle.

It will be understood that whilst the invention has been described with a single spring arrangement, multiple spring systems such as those discussed above in the prior art may also be used. Similarly, if desired, it would be possible to replace the threaded engagement between the collar, spring seat and locking ring with a different engagement system such as locking screws or the like to lock the parts to the strut housing to prevent movement therealong once they have been positioned correctly.

What is claimed is:

1. A suspension strut assembly comprising:
a suspension strut formed by a strut housing having a first end, a second end, an outer surface and an external male thread on the outer surface of the strut housing and extending at least partially between the first and the second end,
a strut rod which is telescopically engaged in the first end of the strut housing; and
an anti-roll bar collar having a plate extending radially outwardly thereof for engaging, in use, with an anti-roll bar, and an annular spring seat,
each of said anti-roll bar collar and said annular spring seat being mounted on the outer surface of the strut housing so as to be moveable therealong,
each of the anti-roll bar collar and the spring seat has an internal female thread complementary to the external male thread of the housing and is threadingly engaged with the external thread of the housing so as to be windable thereon to move each of the collar and spring seat longitudinally along the strut housing,
wherein said threaded engagement preventing longitudinal sliding movement of the collar and spring seat along the strut housing, the spring seat being located on the housing between the collar and the first end of the housing.

2. (canceled)

3. A suspension strut assembly according to claim 1, wherein the male thread of the strut housing is formed directly on the outer surface thereof.

4. A suspension strut assembly according to claim 1, wherein the male thread of the strut housing is provided on a cylindrical sleeve which is slideably engaged onto the strut housing from the first end thereof.

5. A suspension strut assembly according to claim 4, wherein the strut housing includes a lip or flange which forms a seat for the sleeve to locate the longitudinal position of the sleeve on the strut.

6. A suspension strut assembly according to claim 4, further including inter-engaging locating means on the sleeve and the strut housing which engage to lock the sleeve to the housing against relative rotational movement when the sleeve is engaged on the lip or flange.

7. A suspension strut assembly according to claim 6, wherein the inter-engaging locating means comprises a longitudinally extending rib formed on the outer surface of the housing which engages in a longitudinal slot formed in the sleeve to non-rotatably lock the two together.

8. A suspension strut assembly according to claim 1, further including locking means associated with the collar which operates to lock the collar against movement relative to the housing in at least one direction.

9. A suspension strut assembly according to claim 8, wherein the locking means comprises one or more locking screws such as a grub screw provided in the collar.

10. A suspension strut assembly according to claim 8, wherein the locking means takes the form of a locking ring which is screwingly engaged with the male thread of the strut housing and is engaged on the strut housing between the collar and the second end of the strut housing.

11. A kit for forming a suspension strut assembly according to claim 1, comprising:
a suspension strut formed by a strut housing having a first end, a second end, an outer surface and an external male thread on the outer surface of the strut housing extending at least partially between the first and the second end;
a strut rod which is telescopically engaged in the first end of the strut housing;
an anti-roll bar collar having a plate extending radially outwardly thereof for engaging, in use, with an anti-roll bar; and
an annular spring seat,
each of said anti-roll bar collar and said annular spring seat being mounted on the outer surface of the strut housing so as to be moveable therealong,
each of the anti-roll bar collar and the spring seat has an internal female thread complementary to the external male thread of the housing and is threadingly engaged with the external thread of the housing so as to be windable thereon to move each of the collar and spring seat longitudinally along the strut housing, said threaded engagement preventing longitudinal sliding movement of the collar and spring seat along the strut housing,
the spring seat being locatable on the housing between the collar and the first end of the housing.

12. An anti-roll bar collar for a kit according to claim 11, comprising a collar having an inner circumferential surface having a female thread formed thereon and sized to threadingly engage, in use, with the male thread formed on the outer surface of a strut housing so as to be longitudinally moveable therealong, said threaded engagement preventing, in use, longitudinal sliding movement of the collar along the strut housing, and a plate extending radially outwardly thereof for engaging, in use, with an anti-roll bar.
